(19) United States
(12) Patent Application Publication
(10) Pub. No.: US 2025/0199728 A1
(43) Pub. Date: Jun. 19, 2025

(54) INFORMATION PROCESSING APPARATUS, INFORMATION PROCESSING SYSTEM, INFORMATION PROCESSING METHOD, AND NON-TRANSITORY RECORDING MEDIUM

(71) Applicant: Nobuya MONDEN, KANAGAWA (JP)

(72) Inventor: Nobuya MONDEN, KANAGAWA (JP)

(21) Appl. No.: 18/976,371

(22) Filed: Dec. 11, 2024

(30) Foreign Application Priority Data
Dec. 18, 2023 (JP) 2023-213334

(51) Int. Cl. G06F 3/12

(52) U.S. Cl. CPC G06F 3/1208; G06F 3/1275

(57) ABSTRACT

An information processing apparatus includes circuitry to infer a job to be executed, using a trained model that has learned a relation between image data and a job based on training data, the training data associating first image data that is input by a device with a job executed on the first image data according to an instruction from a user among two or more types of jobs executable by the device, based on second image data that is newly input by the device.

### CROSS-REFERENCE TO RELATED APPLICATION

This patent application is based on and claims priority pursuant to 35 U.S.C. § 119 (a) to Japanese Patent Application No. 2023-213334, filed on Dec. 18, 2023, in the Japan Patent Office, the entire disclosure of which is hereby incorporated by reference herein.

### BACKGROUND

### Technical Field

The present disclosure relates to an information processing apparatus, an information processing system, an information processing method, and a non-transitory recording medium.

### Related Art

The multi-functionalization of image processing apparatuses such as multifunction peripherals, copiers, and printers increases the number of setting items for operating the apparatuses. An increase in the number of setting items may lead to an increase in the operational burden on a user.

A technology has been proposed that determines recommended operation information indicating an operation recommended for image information received as an input based on a trained model obtained by machine learning of a relation between image information and operation information indicating a user operation relating to the image information based on a dataset associating the image information with the operation information.

### SUMMARY

The present disclosure described herein provides an information processing apparatus including circuitry to infer a job to be executed, using a trained model that has learned a relation between image data and a job based on training data associating first image data that is input by a device with a job executed on the first image data according to an instruction from a user among two or more types of jobs executable by the device, based on second image data that is newly input by the device.

The present disclosure described herein provides an information processing system including an image processing apparatus including first circuitry, and an information processing apparatus including second circuitry. The first circuitry and the second circuitry being configured to operate in cooperation to infer a job to be executed, using a trained model that has learned a relation between image data and a job based on training data, the training data associating first image data that is input by the image processing apparatus with a job executed on the first image data according to an instruction from a user among two or more types of jobs executable by the image processing apparatus, based on second image data that is newly input by the image processing apparatus, and execute the inferred job.

The present disclosure described herein provides an information processing method performed by a computer. The information processing method includes inferring a job to be executed, using a trained model that has learned a relation between image data and a job based on training data, the training data associating first image data that is input by a device with a job executed on the first image data according to an instruction from a user among two or more types of jobs executable by the device, based on second image data that is newly input by the device.

The present disclosure described herein provides a non-transitory recording medium storing a plurality of instructions which, when executed by one or more processors, causes the one or more processors to perform an information processing method. The information processing method includes inferring a job to be executed, using a trained model that has learned a relation between image data and a job based on training data, the training data associating first image data that is input by a device with a job executed on the first image data according to an instruction from a user among two or more types of jobs executable by the device, based on second image data that is newly input by the device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a configuration of an information processing system according to the first embodiment;

FIG. 2 is a diagram illustrating an example of a hardware configuration of an image processing apparatus according to the first embodiment;

FIG. 3 is a diagram illustrating an example of a hardware configuration of an information processing apparatus according to the first embodiment;

FIG. 4 is a diagram illustrating an example of a functional configuration of the information processing system according to the first embodiment;

FIG. 5 is a sequence diagram for describing an example of a process performed by the information processing system at the time of training of the job inference model;

FIG. 6 is a diagram illustrating an example of a configuration of a user information storage unit;

FIG. 7 is a diagram illustrating an example of a configuration of an image storage unit;

FIG. 8 is a diagram illustrating an example of a configuration of a job information storage unit;

FIG. 9 is a diagram illustrating an example of a configuration of training data;

FIG. 10 is a sequence diagram for describing an example of a process performed by the information processing system at the time of job inference;

FIG. 11 is a diagram illustrating an example of a functional configuration of the information processing system according to the second embodiment;

FIG. 12 is a diagram for describing an example of a process performed by the information processing system according to the second embodiment;

FIG. 13 is a diagram illustrating an example of a functional configuration of the information processing system according to the third embodiment; and

FIG. 14 is a diagram illustrating an example of a functional configuration of the information processing system according to the fourth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

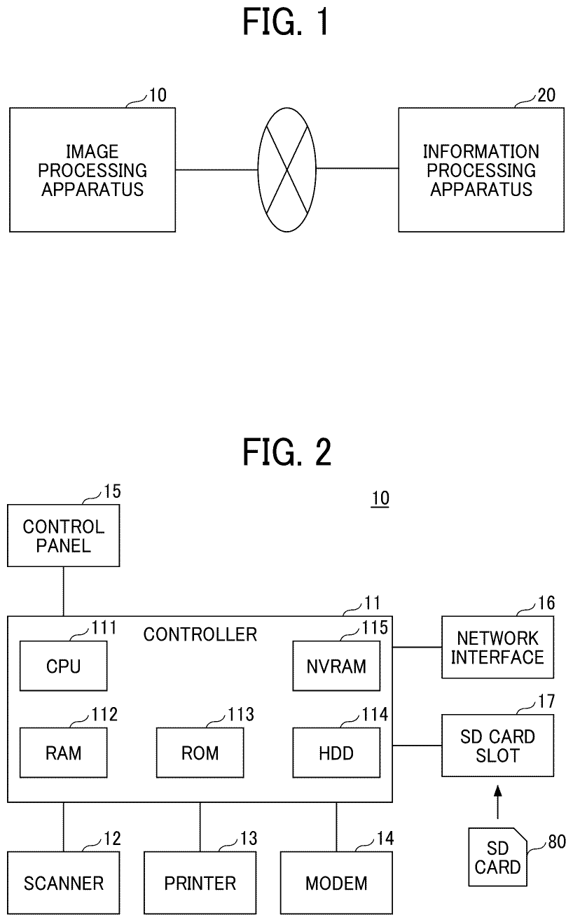

Embodiments of the present disclosure are described below with reference to the drawings. FIG. 1 is a diagram illustrating a configuration of an information processing system according to a first embodiment. In FIG. 1, the information processing system includes one or more image processing apparatuses 10 and an information processing apparatus 20. The image processing apparatus 10 is connected to the information processing apparatus 20 through a network such as a local area network (LAN) or the Internet.

The image processing apparatus 10 is an apparatus that can receive image data that is input and execute a job relating to any one of multiple functions on the image data that is input. In the following description, the image data that is input may be referred to as “input image.” In other words, the image processing apparatus 10 can execute two or more types of jobs. Examples of the functions include facsimile transmission, e-mail transmission, printing, optical character recognition (OCR) processing, and other image processing. The image processing apparatus 10 does not have to be able to execute jobs of all of these functions, provided that it can execute jobs of two or more types of functions. The term “job” refers to processing performed on an image. The type of job depends on the type of function. Accordingly, the image processing apparatus 10 being able to execute jobs relating to two or more types of functions is equivalent to the image processing apparatus 10 being able to execute two or more types of jobs. The unit of “function” may be equivalent to the unit of application. For example, when applications are provided for units such as facsimile transmission, e-mail transmission, printing, OCR processing, and other image processing, these applications may be recognized as units of function.

In the present embodiment, the image processing apparatus 10 executes a job that a machine learning model determines to be suitable for the input image by a machine learning model. In the following description, such a machine learning model may be referred to as a “job inference model.” The job inference model is, for example, a neural network including a convolutional neural network (CNN). Any other suitable model may be used as the job inference model in alternative to the neural network, provided that the model can be trained.

The information processing apparatus 20 is one or more computers that learn the job inference model and infer a job using the job inference model for the input image in the image processing apparatus 10.

In the present embodiment, a situation is assumed in which the image processing apparatus 10 is used for a particular purpose (e.g., business) in an entity such as a company. Therefore, the image processing apparatus 10 receives image data from multiple types of paper documents used for the particular purpose. Alternatively, the image processing apparatus 10 may be used by general consumers such as at convenience stores.

FIG. 2 is a block diagram illustrating an example of a hardware configuration of the image processing apparatus 10 according to the first embodiment. In FIG. 2, the image processing apparatus 10 includes hardware elements such as a controller 11, a scanner 12, a printer 13, a modem 14, a control panel 15, a network interface 16, and a secure digital (SD) card slot 17.

The controller 11 includes a central processing unit (CPU) 111, a random access memory (RAM) 112, a read-only memory (ROM) 113, a hard disk drive (HDD) 114, and a non-volatile random-access memory (NVRAM) 115. The ROM 113 stores various programs and data used by the programs. The RAM 112 is used as a memory area to which a program is loaded and used as a work area for executing a loaded program. The CPU 111 executes a program loaded to the RAM 112 to implement various functions. The HDD 114 stores programs and various data used by the programs. The NVRAM 115 stores various setting information.

The scanner 12 is hardware (image reading means) that scans a document to obtain image data. The printer 13 is hardware (printing means) that forms an image on a sheet in accordance with print data. The modem 14 is hardware for connecting to a telephone line and is used for transmitting and receiving image data by facsimile communication. The control panel 15 is hardware that includes an input device such as keys or buttons that accepts a user input and a display device such as a liquid crystal panel. The liquid crystal panel may have a touch panel function. In this case, the liquid crystal panel also implements a function of the input device. The network interface 16 is hardware to connect the image processing apparatus 10 to a wired or wireless network, such as a LAN. The SD card slot 17 is used for reading programs stored in an SD card 80. Accordingly, in the image processing apparatus 10, not only the programs stored in the ROM 113 but also the programs stored in the SD card 80 may be loaded to the RAM 112 for execution. In addition or in alternative to the SD card 80, any other suitable storage medium may be used, such as a compact disc-read-only memory (CD-compact disc-read-only memory (CD-ROM) or a universal serial bus (USB) memory. In other words, the type of storage medium corresponding to the SD card 80 is not limited to a in specific type. In this case, any other suitable hardware is used in alternative to the SD card slot 17 depending on a type of storage medium.

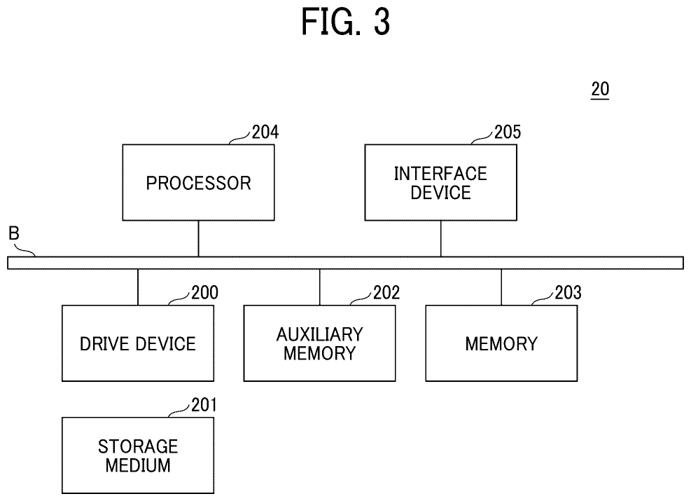

FIG. 3 is a block diagram illustrating an example of a hardware configuration of the information processing apparatus 20 according to the first embodiment. The information processing apparatus 20 of FIG. 3 includes a drive device 200, an auxiliary memory 202, a memory 203, a processor 204, and an interface device 205 that are connected to each other through a bus B.

A program that implements processing of the information processing apparatus 20 is provided by a storage medium 201 such as a CD-ROM. When the storage medium 201 storing the program is set in the drive device 200, the program is installed in the auxiliary memory 202 from the storage medium 201 via the drive device 200. Alternatively, the program may be downloaded from another computer through a network, instead of installed from the storage medium 201. The auxiliary memory 202 stores the installed program and also stores files and data to be used.

In response to an instruction to activate the program, the memory 203 reads the program from the auxiliary memory 202 and stores the program. The processor 204 is a CPU alone or a graphics processing unit (GPU) alone, or both of a CPU and a GPU, and executes functions relating to the information processing apparatus 20 according to a program stored in the memory 203. The interface device 205 is used for connecting the information processing apparatus 20 to a network.

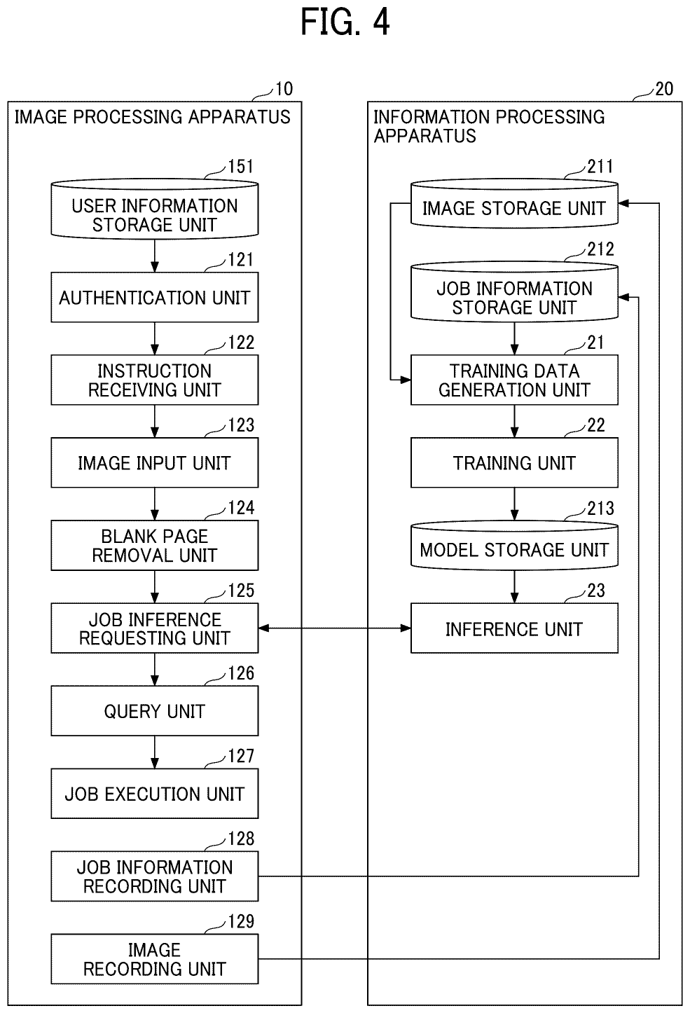

FIG. 4 is a diagram illustrating an example of a functional configuration of the information processing system according to the first embodiment. In FIG. 4, the image processing apparatus 10 includes an authentication unit 121, an instruction receiving unit 122, an image input unit 123, a blank page removal unit 124, a job inference requesting unit 125, a query unit 126, a job execution unit 127, a job information recording unit 128, and an image recording unit 129. Each of these functional units is implemented by processes executed by the CPU 111 according to one or more programs installed on the image processing apparatus 10. The image processing apparatus 10 further uses a user information storage unit 151. The user information storage unit 151 is implemented, for example, by the HDD 114 or a storage device connectable to the image processing apparatus 10 through a network.

The authentication unit 121 authenticates a user who uses the image processing apparatus 10. The user information storage unit 151 is referred to for authentication purpose. The user information storage unit 151 stores information to be used for the authentication of a user who can use the image processing apparatus 10 and attribute information of the user.

The instruction receiving unit 122 receives an instruction to execute a job from a user. In the following description, the instruction to execute a job may be referred to as a “job execution instruction.” The job execution instruction is an instruction including an instruction to read image data from a document and a designation relating to a job to be executed on the image data. After the training of the job inference model, the instruction receiving unit 122 receives an instruction to read image data from a document from the user. In other words, the instruction receiving unit 122 may not receive the designation relating to the job from the user after the training of the job inference model.

The image input unit 123 controls the scanner 12 according to setting information relating to the input (reading) of image data included in the job execution instruction or the instruction to read an image, to input (read) image data from a paper document set in the scanner 12. In the following description, hereinafter, such a setting information may be referred to as a “scan setting.”

The blank page removal unit 124 removes a blank page from the image data input by the image input unit 123 after the training of the job inference model.

The job inference requesting unit 125 requests the inference unit 23 of the information processing apparatus 20 to infer a job to be executed for the image data input by the image input unit 123 after the training of the job inference model. When the blank page removal unit 124 removes a blank page, the page has been removed from the image data. Further, the job inference requesting unit 125 receives the inference result of the job transmitted from the inference unit 23.

The query unit 126 inquires of the user whether the job inferred by the inference unit 23 can be executed.

When the job execution instruction is input by the user, the job execution unit 127 executes the job relating to the job execution instruction. After the training of the job inference model, the job execution unit 127 executes the job inferred by the inference unit 23.

The job information recording unit 128 records job information of a job executed by the job execution unit 127 according to the job execution instruction input by the user in the job information storage unit 212 of the information processing apparatus 20 at the time of training of the job inference model. The term “job information” refers to information relating to a job. The job information is set by a user.

The image recording unit 129 records the image data that is input by the image input unit 123 in the image storage unit 211 of the information processing apparatus 20 at the time of training of the job inference model.

The information processing apparatus 20 includes a training data generation unit 21, a training unit 22, and an inference unit 23. Each of the above-mentioned functional units is implemented by the processor 204 executing one or more programs installed on the information processing apparatus 20. The information processing apparatus 20 further uses an image storage unit 211, a job information storage unit 212, and a model storage unit 213. Each of the above-mentioned storage units can be implemented by using, for example, the auxiliary memory 202 or a storage device that is connectable to the information processing apparatus 20 through a network.

The training data generation unit 21 generates training data of the job inference model by associating image data stored in the image storage unit 211 with job information stored in the job information storage unit 212 for each job. The image storage unit 211 stores image data that is input by the image processing apparatus 10. The job information storage unit 212 stores a job (job information of the job) executed on image data according to an instruction from a user, among two or more types of jobs that the image processing apparatus 10 can execute. Therefore, the training data generated by the training data generation unit 21 is training data in which image data that is input by the image processing apparatus 10 is associated with a job executed on the image data according to an instruction by the user, among two or more types of jobs that the image processing apparatus 10 can execute.

The training unit 22 causes the job inference model to learn the relation between image data and a job based on the training data generated by the training data generation unit 21. Training the job inference model refers to updating a parameter (model parameter) of the job inference model. The training unit 22 records the updated parameter in the model storage unit 213.

The inference unit 23 infers a job to be executed based on image data newly input by the image processing apparatus 10 (image data relating to a request from the job inference requesting unit 125 of the image processing apparatus 10) using the job inference model that learns the relation between image data and a job.

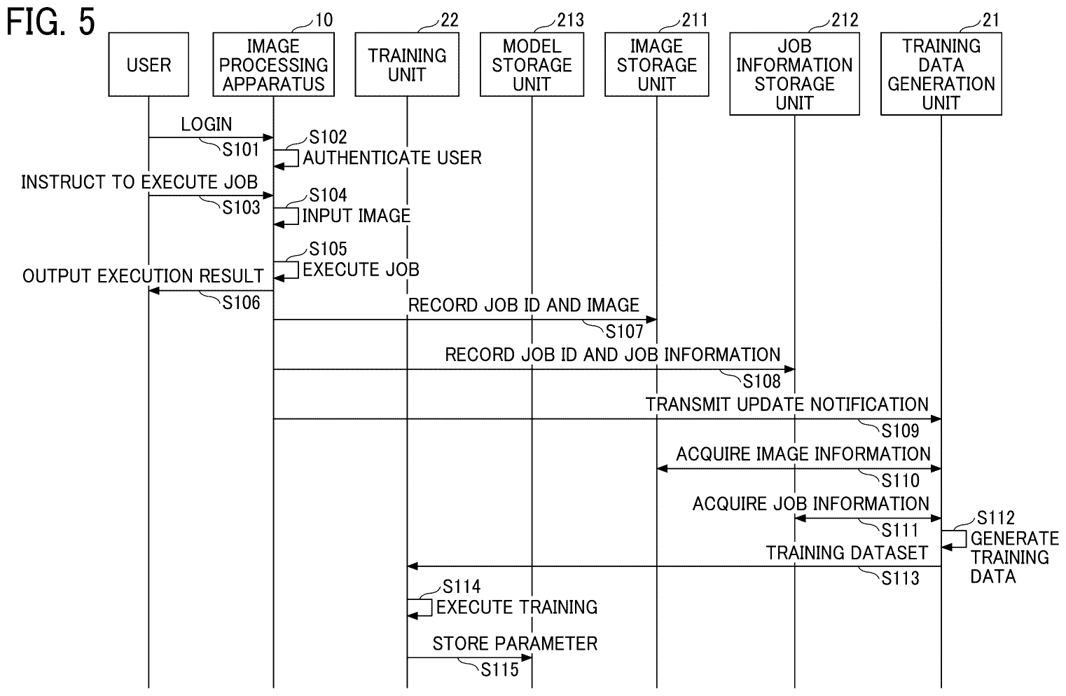

FIG. 5 is a sequence diagram for describing an example of a process performed by the information processing system at the time of training of the job inference model.

In step S101, the authentication unit 121 of the image processing apparatus 10 receives a login operation from a user via a login screen displayed on the control panel 15. By the login operation, information to be used for user authentication, such as a user identifier (ID) and a password, is input as login information. Information used in other known authentication method, such as biometric information, may be input as the login information.

Subsequently, the authentication unit 121 collates the input login information with information stored in the user information storage unit 151 for user authentication (S102).

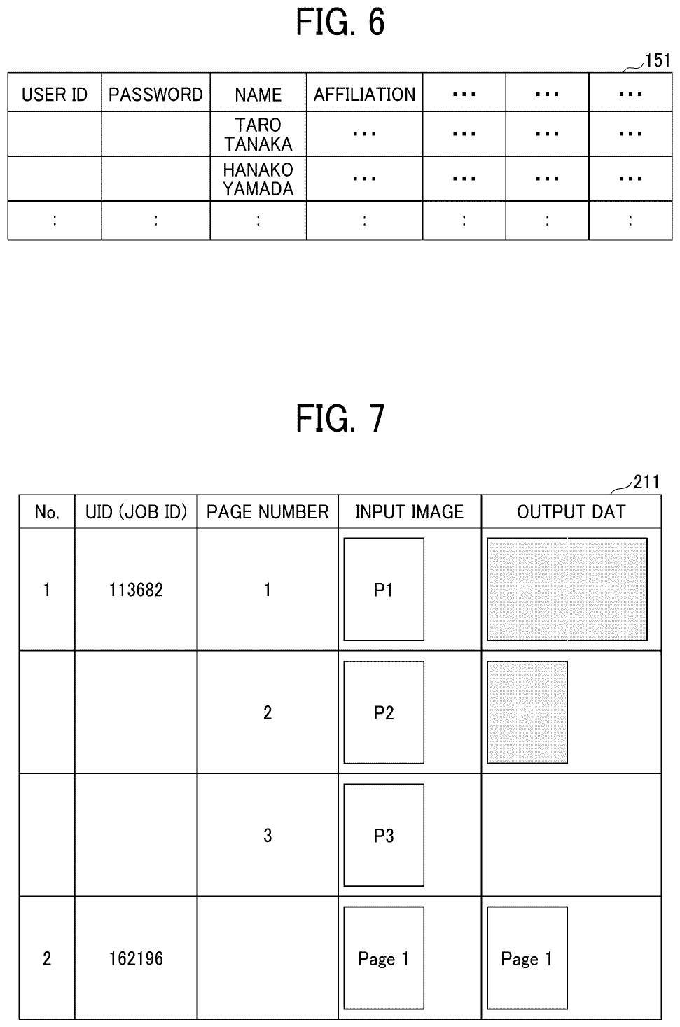

FIG. 6 is a diagram illustrating an example of the configuration of the user information storage unit 151. As illustrated in FIG. 6, the user information storage unit 151 stores, for each user who is permitted to use the image processing apparatus 10, user identification information such as a user ID, a password, a name, and an affiliation.

The user ID is identification information of the user. The password is a valid password registered for the user associated with the user ID. The name is the name of the user associated with the user ID. The affiliation is information (e.g., a department name) indicating an organization to which the user associated with the user ID belongs.

When a record including a set of a user ID and a password that match the input login information is stored in the user information storage unit 151, the authentication unit 121 determines that the authentication is successful, and identifies a user associated with the user ID of the login information as a login user. In this case, the authentication unit 121 records the content of the record including the user ID in the user information storage unit 151 in the RAM 112 as login user information, and erases the login screen.

As a result, a home screen is displayed on the control panel 15. The home screen is a screen for receiving, from the user, a designation of a job to be executed from among two or more types of jobs. When the user information storage unit 151 does not store a record including a set of the user ID and the password that match the input login information, the authentication unit 121 determines that the authentication has failed. In this case, the processes of step S103 and subsequent steps are not performed.

Subsequently, the instruction receiving unit 122 receives a job execution instruction from the user via the home screen (S103). The job execution instruction specifies a scan setting, which is setting information relating to input (reading) of image data and setting information relating to processing (job) to be applied to the input image data. In the following description, the setting information relating to processing (job) to be applied to the input image data may be referred to as “processing setting.” In the following description, the input image data may be referred to as “input image.” Therefore, an operation for the job execution instruction includes one or more input operations for inputting the scan setting and the processing setting. The processing setting is information including an application name of an application corresponding to the job to be applied to the input image, a type of processing in the application, and setting information for the processing by the application. In the following description, the type of processing in the application may be referred to as a “processing type.” In the following description, the setting information for the processing by the application may be referred to simply as “setting information.” The processing type in the processing setting refers to processing selected by the user from among a plurality pieces of processing executable by the application. In other words, the processing type is information that identifies an operation performed by the user on the application.

Subsequently, the image input unit 123 controls the scanner 12 according to the scan setting included in the job execution instruction to input (read) image data (input image) from a paper document that is set in the scanner 12 (S104).

Subsequently, the job execution unit 127 executes processing (job) on the input image according to the processing setting included in the job execution instruction (S105). For example, image processing is performed on the input image. For example, the input image or data obtained by processing the input image is stored in a storage destination according to the processing setting. For example, the input image or data obtained by processing the input image is transmitted to a transmission destination according to the processing setting. When the content of the processing setting is copying, copying is performed for the input image. As described above, the job to be executed on the input image varies depending on the processing setting.

Subsequently, the job execution unit 127 outputs information indicating the execution result of the job to the control panel 15 (S106). This information may be information indicating success or failure of the job, or may be information including data generated by executing the job. In the following description, the data thus generated may be referred to as “output data.”

Subsequently, the image recording unit 129 records a job ID and the input image in association with each other in the image storage unit 211 of the information processing apparatus 20 (S107). In this step, the image recording unit 129 may also record the output data generated by executing the job in the image storage unit 211 in association with the job ID and the input image. The job ID is identification information assigned to each job.

FIG. 7 is a diagram illustrating an example of the configuration of the image storage unit 211. As illustrated in FIG. 7, the image storage unit 211 stores, for each job, image information including a job ID, image data of each page of the input image of the job, and data (e.g., image data) of each page of output data of the job in association with each other.

For example, in the record of No. 1, the image information of the first job indicates that the first page of the output pages is a result of combining the first and second pages of the input image of three pages and reversing the combined pages, and the second page of the output pages is a result of reversing the third page of the input image at its original size.

Subsequently, the job information recording unit 128 records the job ID and job information in association with each other in the job information storage unit 212 of the information processing apparatus 20 (S108). The job information is information about the job, such as information indicating “in what situation, with what settings, and with which application the job is executed.” Specifically, the job information includes information indicating a situation in which the job is executed and the processing setting. In the following description, the information indicating a situation in which the job is executed may be referred to as “situation information.” The situation information corresponding to “in what situation” is, for example, information indicating “who and when.”

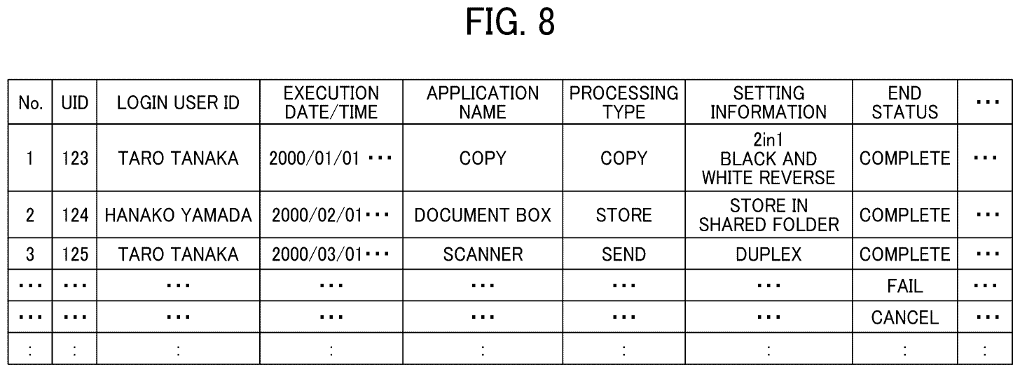

FIG. 8 is a diagram illustrating an example of the configuration of the job information storage unit 212. As illustrated in FIG. 8, the job information storage unit 212 stores, for each job, the job information including a job ID, a login user ID, which is user identification information, an execution date/time, an application name, a processing type, setting information, and an end status. The execution date/time is the date and time when the job was executed. The application name is the name of an application that executed processing on the input image. The processing type is the type of job as described above. The setting information is setting information for a job. The end status is information indicating in what state the job ended. Examples of the end status include “complete,” “fail,” and “cancel.” The “complete” indicates that the job completed normally. The “fail” indicates that an abnormality occurred during the execution of the job and the job was not executed normally. The “cancel” indicates that the execution of the job is canceled according to an instruction from the user.

In such job information, the login user ID and the execution date/time constitute situation information, and a set of the application name, the processing type, and the setting information constitutes the processing setting.

Subsequently, the job information recording unit 128 transmits an update notification indicating the update of the image storage unit 211 and the job information storage unit 212 to the training data generation unit 21 of the information processing apparatus 20 (S109).

In response to receiving the update notification, the training data generation unit 21 performs the processes of steps S110 to S112. Alternatively, the training data generation unit 21 performs the processes of steps S110 to S112 each time the training data generation unit 21 receives the update notification a predetermined number of times.

In step S110, the training data generation unit 21 acquires untrained image information including a job ID, an input image, output data from the image storage unit 211. The untrained image information is image information that is not used for training processing. Subsequently, the training data generation unit 21 acquires untrained job information from the job information storage unit 212 (S111). Subsequently, the training data generation unit 21 generates training data by combining the image information acquired from the image storage unit 211 and the job information acquired from the job information storage unit 212 based on the job ID (S112).

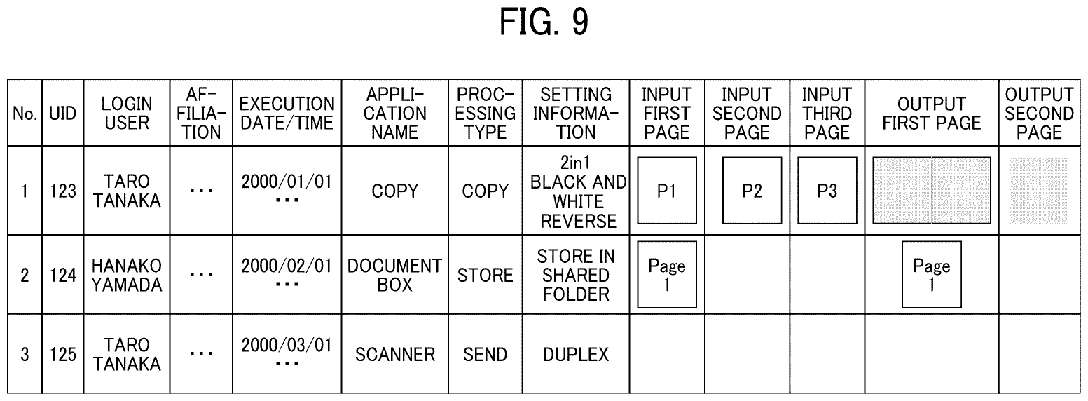

FIG. 9 is a diagram illustrating an example of the configuration of the training data. As illustrated in FIG. 9, the training data is data obtained by combining the image information as illustrated in FIG. 7 and the job information as illustrated in FIG. 8 that have the same job ID. However, the training data generation unit 21 does not generate training data including job information in which the “end status” is “fail” or “cancel” and image information having the same job ID as that the job information. This is because the processing setting included in such job information is unlikely to be correct. In FIG. 9, data of one row corresponds to one piece of training data.

The training data in FIG. 9 includes “affiliation” that is not included in the job information. The affiliation is an organization or a department to which the user belongs, which is stored in the user information storage unit 151 (FIG. 6) for the login user ID. As described above, the training data generation unit 21 can include, in the training data, not only data included in the job information or the image information but also data that can be obtained or derived from data included in the job information or the image information. The “affiliation” is information relating to the user who instructs execution of the job, and is information constituting the situation information.

Subsequently, the training data generation unit 21 transmits a collection of the multiple pieces of generated training data to the training unit 22 (S113). In the following description, the collection of the multiple pieces of generated training data may be referred to as “training dataset.” The training unit 22 performs training processing of the job inference model (S114) using the training data. In the training processing, the training unit 22 causes the job inference model to learn the relation between data corresponding to an input and data corresponding to an output in the training data. The data corresponding to the output in the training data is the processing setting (i.e., the application name, the processing type, and the setting information), and is used as correct answer data.

The training unit 22 inputs the data corresponding to the input in the training data to the job inference model, updates the parameter of the job inference model based on the comparison between the output from the job inference model and the correct answer data in the training data, and stores the updated parameter in the model storage unit 213 (S115). Based on the comparison, the training unit 22 calculates an error (loss) for the output from the job inference model relative to the correct answer data. For example, when the job inference model outputs a probability distribution of the setting values for the items constituting the processing setting, the training unit 22 calculates an error between the probability distribution and a probability distribution of the setting values of the items corresponding to the correct answer data. The probability distribution of the settings of the items corresponding to the correct answer data is, for example, a probability distribution in which the probability of a value as a correct answer is set to 1 and the probability of other values is set to 0 for the possible setting values of the items constituting the processing setting. The training unit 22 updates the parameter of the job inference model based on the error using known technology such as the backpropagation.

On the other hand, the input of the job inference model has variations. In the following description, such variations may be referred to as “input patterns.”

Input pattern 1 is a pattern in which only an input image is input. In this case, the job inference model learns the relation between the input image and the output (processing setting). A correlation is recognized between the content of a paper document which is the source of the input image and processing that a user wants to perform on the input image.

Specifically, processing that a user wants to be performed (i.e., the purpose of using the image processing apparatus 10) tends to be determined according to the type of document such as a contract, an invoice, a development specification, and a presentation material.

The processing setting is determined according to processing to be performed. The job inference model of the input pattern 1 learns the relation between input and output based on such a tendency. When the color in a document does not affect the processing setting, the training unit 22 may use an input image on which binarization has been performed as the input to the job inference model. This applies to the other patterns described below.

Input pattern 2 is a pattern in which a login user ID, which is user identification information in the situation information, is input in addition to the input image. The input pattern 2 is effective, for example, when the setting of some parameters of the processing setting varies depending on a user's preference.

Input pattern 3 is a pattern in which an organization or a department to which the user belongs in the situation information is input in addition to the input image. The types of documents to be handled tend to differ depending on the departments of a company, and processing to be performed by the image processing apparatus 10 for a document to be handled tends to differ depending on the departments. In other words, processing that a certain department causes the image processing apparatus 10 to perform tends to be substantially constant. The job inference model of the input pattern 3 learns such a tendency.

Input pattern 4 is a pattern in which the execution date/time (i.e., an execution timing) when the input image is input in the situation information is input in addition to the input image. The input pattern 3 is effective when, for example, the timing (e.g., time zone) of executing a job affects the processing setting.

Input pattern 5 is a combination of two or more patterns among the input patterns 2 to 4.

The training unit 22 may learn the job inference model for each of the group of user IDs, the group of affiliations, and the group of execution dates/times (time zones), or for each of the groups of combinations of two or more of the user ID, the affiliation, and the execution date/time (time zone) (i.e., for each situation in which the job is executed). In this case, the training unit 22 classifies the training data for each group, and trains, for each group, the job inference model corresponding to the group using the training data classified into the group. Accordingly, the parameter of the job inference model is stored in the model storage unit 213 for each group. In this case, data used as basis for grouping, such as the user ID, the affiliation, and the execution date/time, may not be included in an input to the job inference model. This is because the job inference model is trained with such data being distinguished.

A description is now given of job inference performed using the trained job inference model. The term “job inference” refers to inferring the processing setting for an input image.

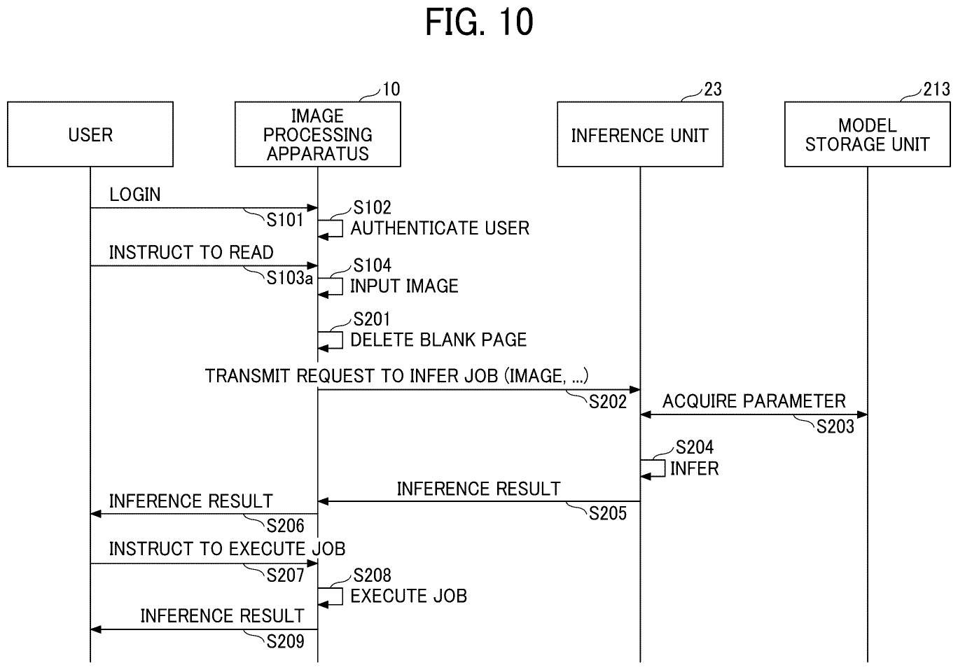

FIG. 10 is a sequence diagram for describing an example of a process performed by the information processing system at the time of the job inference. In FIG. 10, the same steps as those in FIG. 5 are denoted by the same step numbers, and the descriptions thereof are omitted below as appropriate.

The processes from the user login (S101) to the image input (S104) is substantially the same as the processes described in step S101, except that step S103 is replaced with S103a.

In step S103a, the instruction receiving unit 122 receives an instruction to read an image from a document from a user. In the instruction to read an image, it suffices that a scan setting is input. In other words, the processing setting does not have to be input. In step S104, an image is input from a paper document according to the scan setting. In the following description, such an image may be referred to as a “target image.”

Subsequently, the blank page removal unit 124 performs blank page removing processing on the target image (S201). The blank page removing processing refers to processing of removing a blank page. Whether a certain page is blank may be determined by determining whether the ratio of pixels having a luminance value less than a predetermined value is equal to or greater than a threshold value in the certain page, or whether all of the pixel values of an image corresponding to the certain page are values indicating white or constant. The blank page removing processing allows a user to always set a double-sided printing in step S103a without being conscious of whether the paper document is a single-sided document or a double-sided document. Thus, the operation load on the user is reduced. The blank page removing processing is optional and does not have to be always performed.

Subsequently, the job inference requesting unit 125 transmits a job inference request to the information processing apparatus 20 (S202). The job inference request includes input data corresponding to the input pattern of the job inference model. When the input pattern of the job inference model is the input pattern 1, the inference request includes the target image as input data. When the input pattern of the job inference model is the input pattern 2, the inference request includes the target image and the login user ID as input data.

When the input pattern of the job inference model is the input pattern 3, the inference request includes the target image and the affiliation of the login user as input data. The affiliation has been identified in step S102. When the input pattern of the job inference model is the input pattern 4, the inference request includes the target image and the execution date/time (current date and time) at which the target image is input as input data. When the input pattern of the job inference model is the input pattern 5, the inference request includes data that is set as an input in the input pattern 5 as input data.

When the job inference model is generated for each of the group of user IDs, the group of affiliations, and the group of execution dates/times (time zones), or for each of the groups of combinations of two or more of the user ID, the affiliation, and the execution date/time (time zone) (i.e., for each situation), the inference request includes data for identifying the group or for identifying the situation as situation identifier in addition to the target image. Such data for identifying the group or for identifying the situation is, for example, the login user ID, the affiliation of the login user, the current date and time, or a combination of two or more of these.

In response to receiving the inference request, the inference unit 23 of the information processing apparatus 20 acquires the trained parameter from the model storage unit 213 and constructs the job inference model in which the acquired trained parameter is set (S203). In other words, the inference unit 23 loads the trained job inference model to the memory 203. When the job inference model is generated for each of the groups, the inference unit 23 may acquire a parameter corresponding to the situation identifier included in the inference request among the parameters stored for the groups.

Subsequently, the inference unit 23 infers a processing setting for the input data using the job inference model (S204). Specifically, the inference unit 23 inputs the input data to the job inference model. The inference unit 23 infers the processing setting based on the output from the job inference model. For example, when the output from the job inference model is a probability distribution of the setting values of the items constituting the processing setting, the inference unit 23 sets the set of setting values having the highest probability in the items as the inferred value of the processing setting.

Subsequently, the inference unit 23 transmits the processing setting as the inference result to the job inference requesting unit 125 (S205).

When the job inference requesting unit 125 receives the inference result, the query unit 126 displays the inference result on the control panel 15 to inquire of the user whether to execute the job based on the inference result (S206). In this step, the query unit 126 may display a message to inform the user that the job is about to be executed based on the automatically inferred processing setting, for example. The query unit 126 may also display a screen that corresponds to an application having the application name included in the inference result (i.e., a screen on which the user configures settings when using the application). On such a screen, the processing setting included in the inference result has been set. This allows the user to check the processing setting by referring to the familiar screen. On such a screen, the user may modify the setting values of some of the items. When any modification is made, the query unit 126 reflects the modification content in the inference result. This prevents a job different from the user's intention from being executed when the inference result is different from the user's intention. When the inference result is not completely correct, it suffices that the user manually configures the setting value(s) of some limited items. Thus, the setting operation by the user can be simplified.

Subsequently, when the user inputs a job execution instruction based on the processing setting corresponding to the inference result or the processing setting in which the modification to the inference result is reflected (S207), the job execution unit 127 executes processing (i.e., job) on the input image according to the processing setting (S208). Subsequently, the job execution unit 127 outputs information indicating the execution result of the job to the control panel 15 in the same or substantially the same manner as in step S106 of FIG. 5 (S209).

As described above, according to the first embodiment, the information processing system automatically infers a job to be executed using the job inference model that has learned the relation between image data and types, based on image data input by the image processing apparatus 10. This simplifies a user's operation for configuring settings relating to a job. In other words, a user's setting operation relating to multiple types of jobs executed by a device that inputs image data is simplified.

A description is now given of the second embodiment. In the second embodiment, a description is given of elements, members, components, or operations that are different from those of the first embodiment. In other words, elements, members, components, or operations of which description are omitted below may be the same or substantially the same as those of the first embodiment.

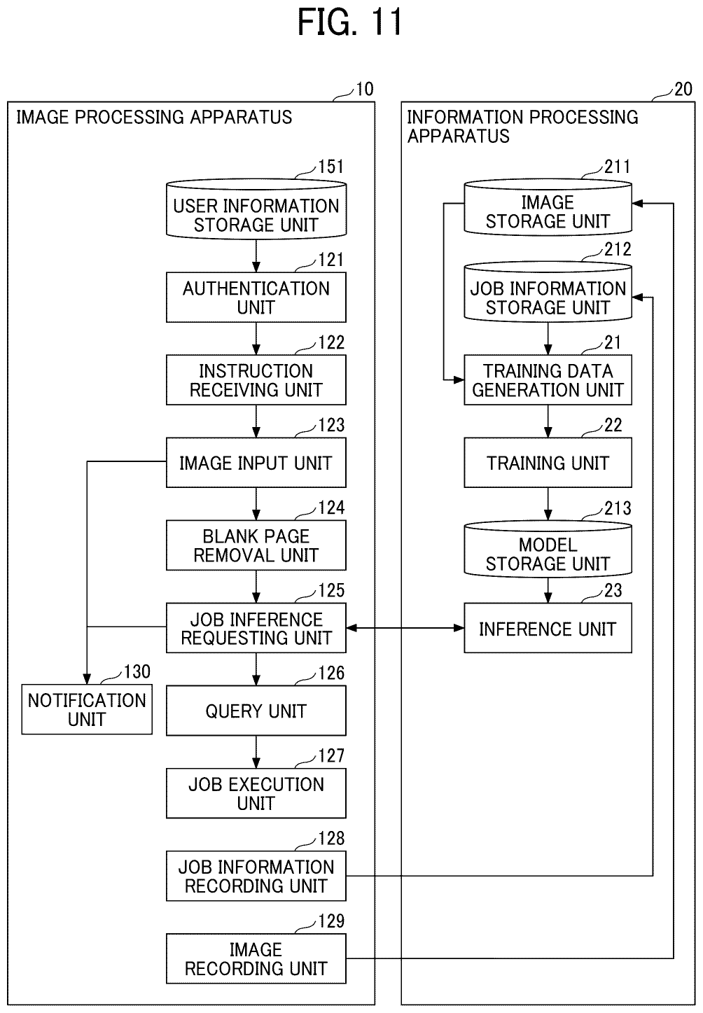

FIG. 11 is a diagram illustrating an example of a functional configuration of the information processing system according to the second embodiment.

In FIG. 11, like reference signs are allocated to the same components as those of FIG. 4, and the descriptions thereof are omitted as appropriate.

In FIG. 11, the image processing apparatus 10 further includes a notification unit 130. The notification unit 130 is implemented by processes executed by the CPU 111 according to one or more programs installed on the image processing apparatus 10.

In the second embodiment, it is assumed that a user designates a job (inputs the processing setting) at the user's discretion even after the training of the job inference model. Even in such a case, the inference unit 23 of the information processing apparatus 20 infers a job to be executed for image data input by the image processing apparatus 10. The notification unit 130 outputs a predetermined notification based on a comparison between the job designated by the user for the image data and the job inferred by the inference unit 23. For example, the notification unit 130 performs a predetermined notification when the job designated by the user differs from the job inferred by the inference unit 23 or when there is a gap between the job designated by the user and the job inferred by the inference unit 23. The predetermined notification may be, for example, a warning indicating that the designation (i.e., processing setting) by the user may be incorrect.

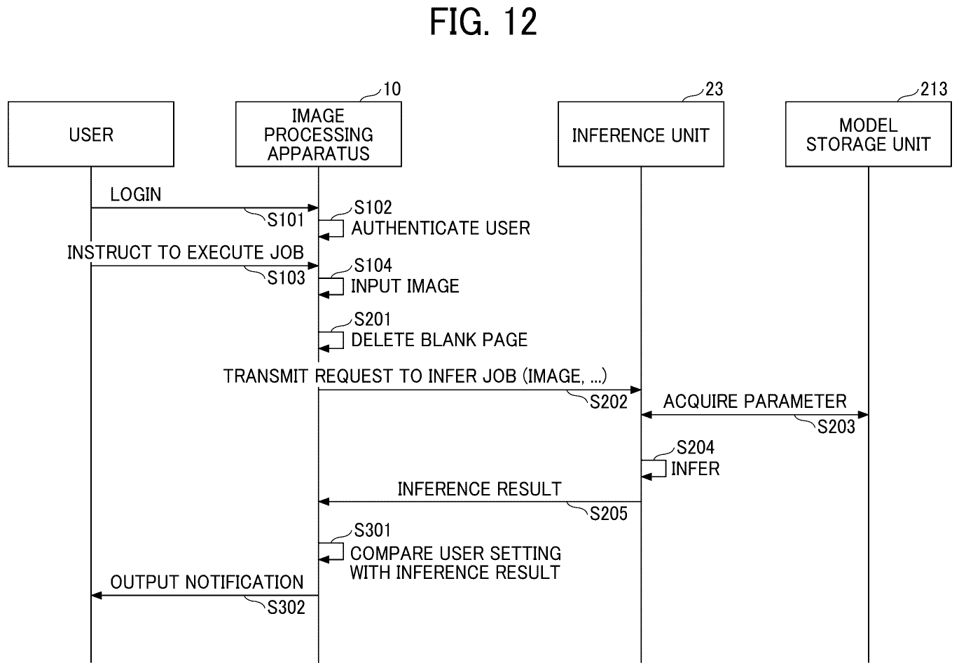

FIG. 12 is a diagram for describing an example of a process performed by the information processing system according to the second embodiment. In FIG. 12, the same steps as those in FIG. 5 or FIG. 10 are denoted by the same step numbers, and the descriptions thereof are omitted below as appropriate. It is assumed that the job inference model has been trained at the start of the process of FIG. 12.

First, as described with reference to FIG. 5, the processes from the user's login to the reading of image data are performed (S101 to S104). In step S103, the execution of the job is instructed (the job is designated) in the same or substantially the same manner as described with reference to FIG. 5. In other words, the user also designates the processing setting.

Subsequently, as in FIG. 10, the processes of steps S202 to S205 are performed to infer a job (processing setting) for the image data.

Subsequently, the notification unit 130 compares the job (processing setting) designated by the user in step S103 with the job (processing setting) inferred by the inference unit 23 in step S204 to determine whether there is a difference satisfying a predetermined condition between the jobs (S301). The predetermined condition may be, for example, that the two values do not exactly match, or that the two values are different for one or more items including a setting value with a high probability (accuracy) (equal to or higher than a threshold value) in the probability distribution of the setting values of the items constituting the processing setting output by the job inference model. Other conditions may be set as the predetermined condition.

When there is a difference satisfying the predetermined condition, the notification unit 130 output the predetermined notification to the control panel 15 (S302). In this case, the subsequent processes do not have to be performed. In other words, the job may not be executed.

When there is no difference satisfying the predetermined condition, for example, processes of steps S105 to S115 of FIG. 5 may be performed to additionally train the job inference model.

According to the second embodiment, for example, when a processing setting configured by a user is away from the user's usual tasks (e.g., when the user tries to store an invoice in a task folder although the user usually sends an invoice to the general affairs department), the error can be detected and the execution of the incorrect job can be prevented.

A description is now given of the third embodiment. In the third embodiment, a description is given of elements, members, components, or operations that are different from those of the first embodiment. In other words, elements, members, components, or operations of which description are omitted below may be the same or substantially the same as those of the first embodiment.

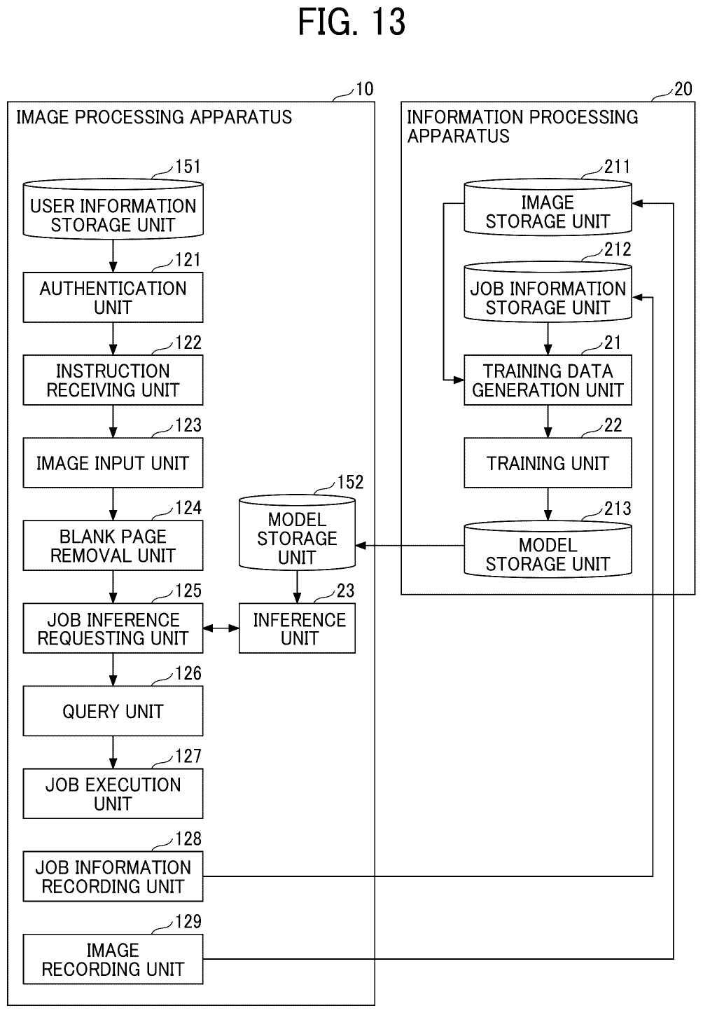

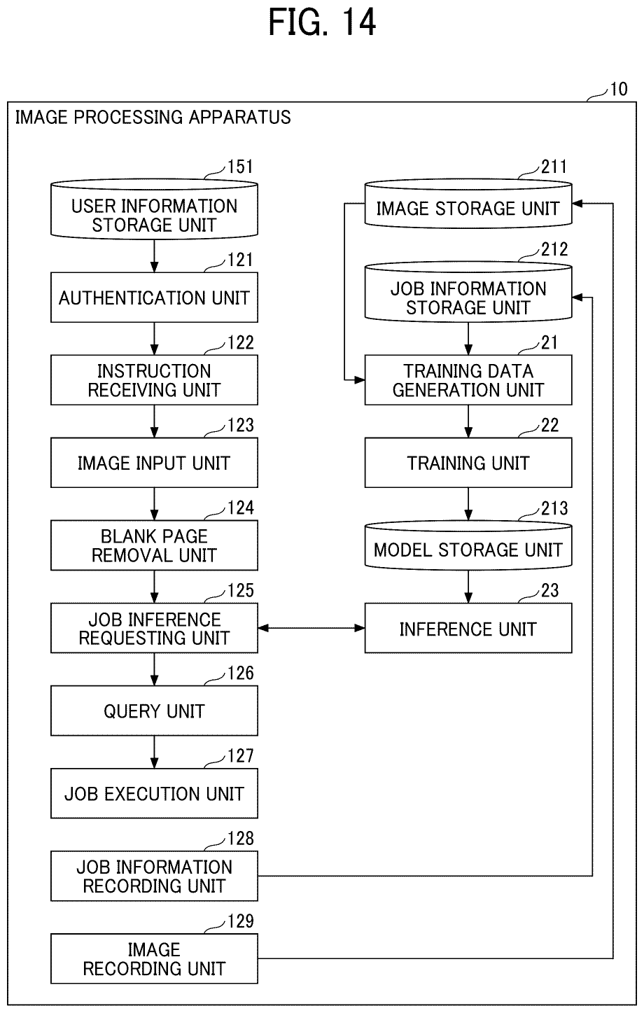

FIG. 13 is a diagram illustrating an example of a functional configuration of the information processing system according to the third embodiment.

In FIG. 13, like reference signs are allocated to the same components as those of FIG. 4, and the descriptions thereof are omitted as appropriate.

In FIG. 13, the image processing apparatus 10 includes the inference unit 23. The image processing apparatus 10 further includes a model storage unit 152. The model storage unit 152 stores a copy of the parameters stored in the model storage unit 213. Accordingly, in the third embodiment, the image processing apparatus 10 infers a job. When inferring a job, the inference unit 23 uses the parameters stored in the model storage unit 152.

In the third embodiment, the image processing apparatus 10 may include the notification unit 130 illustrated in FIG. 11.

A description is now given of the fourth embodiment. In the fourth embodiment, a description is given of elements, members, components, or operations that are different from those of the first embodiment. In other words, elements, members, components, or operations of which description are omitted below may be the same or substantially the same as those of the first embodiment.

FIG. 14 is a diagram illustrating an example of a functional configuration of the information processing system according to the fourth embodiment.

In FIG. 14, like reference signs are allocated to the same components as those of FIG. 4, and the descriptions thereof are omitted as appropriate.

In FIG. 14, the image processing apparatus 10 has all the functions of the information processing apparatus 20 in FIG. 4. In other words, the image processing apparatus 10 alone constitutes the information processing system. Accordingly, in the fourth embodiment, the image processing apparatus 10 trains the job inference model and infers a job.

In the fourth embodiment, the image processing apparatus 10 may include the notification unit 130 illustrated in FIG. 11.

The functionality of the elements of the above-described embodiments may be implemented using circuitry or processing circuitry which includes general purpose processors, special purpose processors, integrated circuits, application-specific integrated circuits (ASICs), digital signal processors (DSPs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The apparatuses or devices described in the embodiments described above are merely one example of multiple computing environments that implement one or more embodiments of the disclosure.

In some embodiments, the information processing apparatus 20 includes multiple computing devices, such as a server cluster. The multiple computing devices communicate with one another through any type of communication link including, for example, a network and a shared memory, and perform the processes disclosed in the present disclosure. In substantially the same manner, the image processing apparatus 10 may include such multiple computing devices configured to communicate with one another.

According to the related art, an operation recommended for image information selected by a user is determined when printing is performed. For this reason, it is difficult to reduce the operation burden on a user for multiple types of jobs (e.g., printing, facsimile transmission, mail transmission, cloud storage) including jobs other than printing.

According to one or more embodiments of the present disclosure, a user's setting operation relating to multiple types of jobs executed by a device that inputs image data is simplified.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

Aspects of the present disclosure are, for example, as follows.

### Aspect 1

According to Aspect 1, an information processing system includes an inference unit to infer a job to be executed, using a trained model that has learned a relation between image data and a job based on training data, the training data associating first image data that is input by a device with a job executed on the first image data according to an instruction from a user among two or more types of jobs executable by the device, based on second image data that is newly input by the device.

### Aspect 2

According to Aspect 2, the information processing system of Aspect 1 further includes a job execution unit that executes the job inferred by the inference unit.

### Aspect 3

According to Aspect 3, in the information processing system of Aspect 1 or 2, the inference unit infers a job to be executed, using a trained model that has learned a relation between image data and information indicating a situation in which a job has been executed on the first image data, and a job executed on the first image data based on training data associating the first image data, the information, and the job with each other, based on second image data that is newly input by the device and the information when the second image data is input.

### Aspect 4

According to Aspect 4, in the information processing system of Aspect 3, the information indicating the situation is identification information of a user who uses the device.

### Aspect 5

According to Aspect 5, in the information processing system of Aspect 3, the information indicating the situation is information on an organization to which a user who uses the device belongs.

### Aspect 6

According to Aspect 6, in the information processing system of Aspect 3, the information indicating the situation is information on a time at which the second image data is input.

### Aspect 7

According to Aspect 7, the information processing system of any one of Aspects 1 to 3 further includes a blank page removal unit to remove a blank page from the second image data. The inference unit infers the job to be executed based on the second image data from which the blank page is removed, using the trained model.

### Aspect 8

According to Aspect 8, in the information processing system of any one of Aspects 1 to 4, the inference unit infers the job to be executed based on the second image data that is newly input by the device and the trained model corresponding to a situation when the second image data is input, among trained models that have learned a relationship between the image data and the job for each of situations in which the job has been executed based on the training data associating the first image data with the job executed on the first image data.

### Aspect 9

According to Aspect 9, the information processing system of any one of Aspects 1 to 5 further includes a query unit to inquire of a user whether the job inferred by the inference unit is to be executed.

### Aspect 10

According to Aspect 10, the information processing system of any one of Aspects 1 to 6 further includes a notification unit that outputs a predetermined notification based on a comparison between a job designated by the user for the second image data and the job inferred by the inference unit.

### Aspect 11

According to Aspect 11, an information processing system includes an image processing apparatus and an information processing apparatus. The information processing apparatus includes an inference unit to infer a job to be executed, using a trained model that has learned a relation between image data and a job based on training data, the training data associating first image data that is input by the image processing apparatus with a job executed on the first image data according to an instruction from a user among two or more types of jobs executable by the image processing apparatus, based on second image data that is newly input by the image processing apparatus. The image processing apparatus includes a job execution unit that executes the job inferred by the inference unit.

### Aspect 12

According to Aspect 12, an information processing system includes a training unit that causes a model to learn a relation between image data and a job based on training data associating first image data that is input by a device with a job executed on the first image data according to an instruction from a user among two or more types of jobs executable by the device.

### Aspect 13

According to Aspect 13, an image processing apparatus includes a model storage unit that stores a trained model that has learned a relation between image data and a job based on training data associating first image data that is input by a device with a job executed on the first image data according to an instruction from a user among two or more types of jobs executable by the device. The image processing apparatus includes an inference unit to infer a job to be executed based on second image data that is newly input by the device, using the trained model.

### Aspect 14

According to Aspect 14, an information processing method performed by a computer includes inferring a job to be executed, using a trained model that has learned a relation between image data and a job based on training data associating first image data that is input by a device with a job executed on the first image data according to an instruction from a user among two or more types of jobs executable by the device, based on second image data that is newly input by the device.

### Aspect 15

According to Aspect 15, a program causes a computer to perform a method including inferring a job to be executed, using a trained model that has learned a relation between image data and a job based on training data associating first image data that is input by a device with a job executed on the first image data according to an instruction from a user among two or more types of jobs executable by the device, based on second image data that is newly input by the device.

1. An information processing apparatus, comprising circuitry configured to
infer a job to be executed, using a trained model that has learned a relation between image data and a job based on training data, the training data associating first image data that is input by a device with a job executed on the first image data according to an instruction from a user among two or more types of jobs executable by the device, based on second image data that is newly input by the device.

2. The information processing apparatus according to claim 1, wherein the trained model has learned a relation between image data and information indicating a situation in which a job has been executed on the first image data, and the job executed on the first image data based on the training data,
the training data further associating the information indicating the situation with the first image data and the job executed on the first image data,
wherein the circuitry infers the job to be executed based on the second image data that is newly input by the device and the information indicating the situation when the second image data is input.

3. The information processing apparatus according to claim 2, wherein the information indicating the situation is identification information of a user who uses the device.

4. The information processing apparatus according to claim 2, wherein the information indicating the situation is information on an organization to which a user who uses the device belongs.

5. The information processing apparatus according to claim 2, wherein the information indicating the situation is information on a time at which the second image data is input.

6. The information processing apparatus according to claim 1, wherein the circuitry is further configured to:
remove a blank page from the second image data; and
infer the job to be executed based on the second image data from which the blank page is removed, using the trained model.

7. The information processing apparatus according to claim 1, wherein the circuitry infers the job to be executed based on the second image data that is newly input by the device, using the trained model corresponding to a situation when the second image data is input, the trained model having been selected from among trained models that have learned a relationship between the image data and the job for each of situations in which the job has been executed based on the training data associating the first image data with the job executed on the first image data.

8. The information processing apparatus according to claim 1, wherein the circuitry is further configured to inquire of the user whether the inferred job is to be executed.

9. An information processing system, comprising:
an image processing apparatus including first circuitry; and
an information processing apparatus including second circuitry,
the first circuitry and the second circuitry being configured to operate in cooperation to:
infer a job to be executed, using a trained model that has learned a relation between image data and a job based on training data, the training data associating first image data that is input by the image processing apparatus with a job executed on the first image data according to an instruction from a user among two or more types of jobs executable by the image processing apparatus, based on second image data that is newly input by the image processing apparatus; and
execute the inferred job.

10. The information processing system according to claim 9, wherein the first circuitry is configured to execute the inferred job.

11. The information processing system according to claim 9, wherein the first circuitry is further configured to output a predetermined notification based on a comparison between a job designated by the user for the second image data and the inferred job.

12. The information processing system according to claim 9, wherein the first circuitry and the second circuitry are further configured to operate in cooperation to cause a model to learn the relation between the image data and the job based on the training data.

13. The information processing system according to claim 9, wherein
the image processing apparatus includes a memory that stores the trained model, and
the first circuitry infers the job to be executed based on the second image data that is newly input by the information processing apparatus, using the trained model.

14. An information processing method performed by a computer, comprising inferring a job to be executed, using a trained model that has learned a relation between image data and a job based on training data, the training data associating first image data that is input by a device with a job executed on the first image data according to an instruction from a user among two or more types of jobs executable by the device, based on second image data that is newly input by the device.

15. A non-transitory recording medium storing a plurality of instructions which, when executed by one or more processors, causes the one or more processors to perform the method according to claim 14.
